(19) United States
(12) Patent Application Publication
(10) Pub. No.: US 2020/0097674 A1
(43) Pub. Date: Mar. 26, 2020

(54) INFORMATION PROCESSING DEVICE AND NON-TRANSITORY COMPUTER READABLE MEDIUM

(71) Applicant: FUJI XEROX CO.,LTD., Tokyo (JP)

(72) Inventor: Kentaro TAKANO, Kanagawa (JP)

(73) Assignee: FUJI XEROX CO.,LTD., Tokyo (JP)

(21) Appl. No.: 16/262,962

(22) Filed: Jan. 31, 2019

(30) Foreign Application Priority Data
Sep. 25, 2018 (JP) 2018-178474

(51) Int. Cl. G06F 21/62; G06F 16/93; G06F 21/31

(52) U.S. Cl. CPC G06F 21/6218; G06F 21/316; G06F 16/93

(57) ABSTRACT

An information processing device includes a display and a changing unit. The display displays a document that an authorized user having an authorization is able to access. The changing unit changes a presentation mode of the document in accordance with a probability that an unauthorized user is able to view or read content of the document. The probability is calculated from a situation where the authorized user is displaying the document.

### CROSS-REFERENCE TO RELATED APPLICATIONS

This application is based on and claims priority under 35 USC 119 from Japanese Patent Application No. 2018-178474 filed Sep. 25, 2018.

### BACKGROUND

### (i) Technical Field

The present disclosure relates to an information processing device and a non-transitory computer readable medium.

### (ii) Related Art

Japanese Unexamined Patent Application Publication No. 2004-287789 discloses the following technology to provide a processing device that is able to inform a user that an access right is set in a document file. When a user opens a document file in which an access right is set, the processing device first displays an access right level set in this document file and an access right level provided for the user, and then displays the document file including an access right image indicating the content of the access right. The access right image is disposed on a confidential portion of the document file in which the access right is set. This allows the user to understand the confidential level of the document and a portion to be confidential. It is thus possible to prevent a leakage of confidential information of a document from a user accessing the document.

Japanese Unexamined Patent Application Publication No. 2011-100220 discloses the following technology to provide an information display apparatus, a display control program, and an information display method that are able to safely and effectively display information. The information display apparatus having a display device at least includes a display time setter and a display controller. The display time setter sets a display time for each of plural pages forming a document. The display controller displays each page of the document on the display device and then erases a corresponding page displayed on the display device after the lapse of the display time set for this page. Before erasing a page displayed on the display device, the display controller displays warning information that the page displayed on the display device will be erased. Without an instruction to continue to display the page in response to the warning information, the display controller erases the page displayed on the display device.

### SUMMARY

While a document is displayed by a user having an access authorization for this document, an unauthorized user may still have an opportunity to read the content of this document by hacking or by physically sneaking a look at the document.

Aspects of non-limiting embodiments of the present disclosure relate to an information processing device and a non-transitory computer readable medium storing an information processing program that are able to inform a user having an authorization to access a document that an unauthorized user may be able to read the content of this document.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing device including a display and a changing unit. The display displays a document that an authorized user having an authorization is able to access. The changing unit changes a presentation mode of the document in accordance with a probability that an unauthorized user is able to view or read content of the document. The probability is calculated from a situation where the authorized user is displaying the document.

### BRIEF DESCRIPTION OF THE DRAWINGS

An exemplary embodiment of the present disclosure will be described in detail based on the following figures, wherein:

FIG. 1 is a block diagram illustrating conceptual modules forming an example of the configuration of the exemplary embodiment;

FIGS. 2A and 2B illustrate examples of the system configuration utilizing the exemplary embodiment;

FIG. 3 is a flowchart illustrating an example of processing executed in the exemplary embodiment;

FIGS. 4A through 4C illustrate an example of processing executed in the exemplary embodiment;

FIG. 5 illustrates an example of processing executed in the exemplary embodiment;

FIG. 6 illustrates an example of processing executed in the exemplary embodiment;

FIG. 7 is a flowchart illustrating an example of processing executed in the exemplary embodiment;

FIG. 8 is a flowchart illustrating an example of processing executed in the exemplary embodiment;

FIG. 9 is a flowchart illustrating an example of processing executed in the exemplary embodiment;

FIG. 10 is a flowchart illustrating an example of processing executed in the exemplary embodiment;

FIG. 11 is a flowchart illustrating an example of processing executed in the exemplary embodiment;

FIG. 12 is a flowchart illustrating an example of processing executed in the exemplary embodiment;

FIG. 13 is a flowchart illustrating an example of processing executed in the exemplary embodiment;

FIG. 14 is a flowchart illustrating an example of processing executed in the exemplary embodiment;

FIG. 15 is a flowchart illustrating an example of processing executed in the exemplary embodiment;

FIGS. 16A through 16C illustrate an example of processing executed in the exemplary embodiment;

FIG. 17 illustrates examples of the switching speed of a display mode according to the exemplary embodiment;

FIG. 18 illustrates examples of the switching speed of a display mode according to the exemplary embodiment;

FIG. 19 illustrates an example of the data structure of a disclosure range table;

FIGS. 20A through 20C illustrate an example of processing executed in the exemplary embodiment;

FIG. 21 is a flowchart illustrating an example of processing executed in the exemplary embodiment;

FIG. 22 is a flowchart illustrating an example of processing executed in the exemplary embodiment;

FIG. 23 illustrates an example of processing executed in the exemplary embodiment; and

FIG. 24 is a block diagram illustrating an example of the hardware configuration of a computer implementing the exemplary embodiment.

### DETAILED DESCRIPTION

An exemplary embodiment of the disclosure will be described below with reference to the accompanying drawings.

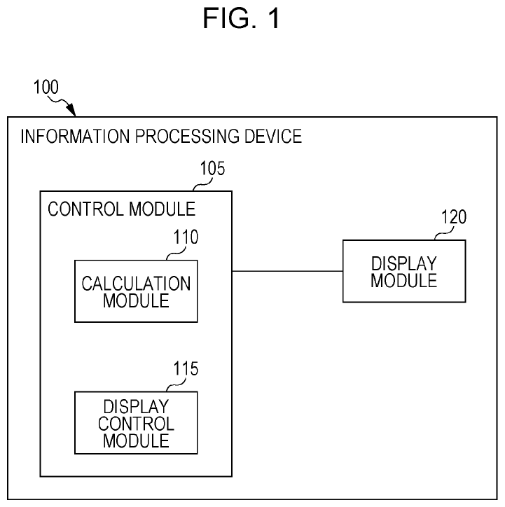

FIG. 1 is a block diagram illustrating conceptual modules forming an example of the configuration of the exemplary embodiment.

Generally, modules are software (computer programs) components or hardware components that can be logically separated from one another. The modules of the exemplary embodiment of the disclosure are, not only modules of a computer program, but also modules of a hardware configuration. Thus, the exemplary embodiment will also be described in the form of a computer program for allowing a computer to function as those modules (a program for causing a computer to execute program steps, a program for allowing a computer to function as corresponding units, or a computer program for allowing a computer to implement corresponding functions), a system, and a method. While expressions such as “store”, “storing”, “being stored”, and equivalents thereof are used for the sake of description, such expressions indicate, when the exemplary embodiments relate to a computer program, storing the computer program in a storage device or performing control so that the computer program will be stored in a storage device. Modules may correspond to functions based on a one-to-one relationship. In terms of implementation, however, one module may be constituted by one program, or plural modules may be constituted by one program. Conversely, one module may be constituted by plural programs. Additionally, plural modules may be executed by using a single computer, or one module may be executed by using plural computers in a distributed or parallel environment. One module may integrate another module therein. Hereinafter, the term “connection” includes not only physical connection, but also logical connection (sending and receiving of data, giving instructions, reference relationships among data elements, login, etc.). The term “predetermined” means being determined prior to a certain operation, and includes the meaning of being determined prior to a certain operation before starting processing of the exemplary embodiment, and also includes the meaning of being determined prior to a certain operation even after starting processing of the exemplary embodiment, in accordance with the current situation/state or in accordance with the previous situation/state. If there are plural “predetermined values”, they may be different values, or two or more of the values (or all the values) may be the same. A description having the meaning “in the case of A, B is performed” is used as the meaning “it is determined whether the case A is satisfied, and B is performed if it is determined that the case A is satisfied”, unless such a determination is unnecessary. If elements are enumerated, such as “A, B, and C”, they are only examples unless otherwise stated, and such enumeration includes the meaning that only one of them (only the element A, for example) is selected.

A system or an apparatus may be implemented by connecting plural computers, hardware units, devices, etc., to one another via a communication medium, such as a network (including communication connection based on a one-to-one correspondence), or may be implemented by a single computer, hardware unit, device, etc. The terms “apparatus” and “system” are used synonymously. The term “system” does not include merely a man-made social “mechanism” (social system).

Additionally, every time an operation is performed by using a corresponding module or every time each of plural operations is performed by using a corresponding module, target information is read from a storage device, and after performing the operation, a processing result is written into the storage device. A description of reading from the storage device before an operation or writing into the storage device after an operation may be omitted. Examples of the storage device may be a hard disk, a random access memory (RAM), an external storage medium, a storage device using a communication line, and a register within a central processing unit (CPU).

An information processing device 100 of this exemplary embodiment, which displays a document, includes a control module 105 and a display module 120, as shown in FIG. 1.

A document to be displayed by the information processing device 100 is also called a file. Examples of a document is text data, numeric data, graphics data, image data, video data, sound data, and a combination thereof, and is an object that may be viewed or read. Specific examples of a document are documents created by a document creating program (such as word-processing software), images read by an image reader (such as a scanner), web pages, photos, and video images.

The control module 105 includes a calculation module 110 and a display control module 115, and is connected to the display module 120. The control module 105 controls the display mode of a document displayed by the display module 120.

The calculation module 110 calculates the probability that a user without an authorization to access a document will be able to view or read the content of the document, based on a situation where a user with an authorization to access the document is displaying the document.

A user without an access authorization is other than a user with an access authorization who has opened a document. Such an unauthorized user may secretly look at the document displayed on a display. If a user with an access authorization opens a document by using a display within the office, other users in the office are less likely to be unauthorized users, and the probability that a user without an access authorization will be able to view or read the content of the document becomes low. However, if a user with an access authorization opens a document by using a display outside the office, other users are more likely to be unauthorized users, and the above-described probability becomes high.

The calculation module 110 may calculate the above-described probability in the following manner.

(1) The probability is calculated in accordance with the time for which a document is being presented (including the time for which a document is being displayed). More specifically, as the time for which a document is being presented is longer, the probability is calculated to be higher. In other words, as the time for which a document is being presented is shorter, the probability is calculated to be lower. In this calculation option, an expression (increasing function) for calculating the probability by using the time as a variable may be used. A table in which the time and the probability having the above-described relationship are associated with each other may alternatively be used. Instead of the time for which a document is being presented, the time for which no operation is performed on the presented document may be used.

(2) The probability is calculated in accordance with the degree of restrictions regarding users authorized to access a document. More specifically, as the degree of restrictions is higher, the probability is calculated to be higher. In other words, as the degree of restrictions is lower, the probability is calculated to be lower. If users authorized to access a document are restricted to users of high positions in a certain organization, for example, the degree of restrictions is high. If no restrictions are imposed on users authorized to access a document, the degree of restrictions is low. Details of the degrees of restrictions will be discussed later by using a disclosure range table 1900 shown in FIG. 19. In this calculation option, an expression (increasing function) for calculating the probability by using the degree of restrictions regarding users authorized to access a document as a variable may be used. A table in which the degree of restrictions and the probability having the above-described relationship are associated with each other may alternatively be used.

(3) The probability is calculated in accordance with the location where a document is accessed. More specifically, if the security of a location where a document is accessed is low, the probability is calculated to be high. If the security of a location where a document is accessed is high, the probability is calculated to be low. Locations where the security is low are public places, for example. In this calculation option, a table in which the location where a document is accessed and the probability having the above-described relationship are associated with each other may be used.

(4) The probability is calculated in accordance with the security state of a terminal displaying a document. If the security state of a terminal is not a sufficient level, the probability is calculated to be high. If the security state of a terminal is a sufficient level, the probability is calculated to be low. In this calculation option, a table in which the security state of a terminal and the probability having the above-described relationship are associated with each other may be used.

(5) The probability is calculated in accordance with the angle of a screen displaying a document. If the screen is positioned at an angle at which a document is viewable by another user, the probability is calculated to be high. If the screen is positioned at an angle at which a document is not viewable by another user, the probability is calculated to be low. In this calculation option, an expression (increasing function) for calculating the probability by using the angle of a screen as a variable may be used. A table in which the angle of a screen and the probability having the above-described relationship are associated with each other may alternatively be used.

(6) The probability is calculated according to whether an operation is performed on a document. If no operation is performed on a document, the probability is calculated to be high. If an operation is performed on a document, the probability is calculated to be low. In this calculation option, a table in which information concerning whether an operation is performed on a document and the probability having the above-described relationship are associated with each other may be used.

(7) The probability is calculated in accordance with the type of operation performed on a document. For example, when the screen displaying a document is a touchscreen, if the type of operation is an operation performed on the touchscreen with a finger or a pen, the probability is calculated to be low. If the type of operation is an operation performed on the touchscreen without using a finger or a pen (more specifically, by using a keyboard), the probability is calculated to be high. In this calculation option, a table in which the type of operation (more specifically, information concerning whether an operation is performed on a touchscreen with a finger or a pen) and the probability having the above-described relationship are associated with each other may be used.

If the type of operation is an enlargement operation, the probability may be calculated to be high. If the type of operation is other than an enlargement operation, the probability may be calculated to be low. If the type of operation is a reduction operation, the probability is calculated to be even lower. In this calculation option, a table in which the type of operation (more specifically, information concerning whether an enlargement operation or a reduction operation is performed) and the probability having the above-described relationship are associated with each other may be used.

(8) The probability is calculated in accordance with the time and date at and on which a document is displayed. If the time and date at and on which a document is displayed is during non-business hours, the probability is calculated to be high. Conversely, if the time and date at and on which a document is displayed is during business hours, the probability is calculated to be low. In this calculation option, a table in which the time and date of display of a document and the probability having the above-described relationship are associated with each other may be used.

(9) If a document is set to be unavailable for access and is then set to be available for access again, the probability is calculated in accordance with the time for which the document has been unavailable (such a time will also be called the document unavailable time). For example, the probability is calculated as a result of comparing the document unavailable time with a threshold determined by using a screen lock start time. More specifically, if the document unavailable time is smaller than or smaller than or equal to the threshold, the probability is calculated to be high. If the document unavailable time is greater than or equal to or exceeds the threshold, the probability is calculated to be low.

The display control module 115 performs control so that the presentation mode of a document can be changed in accordance with whether the probability calculated by the calculation module 110 is high or low. A determination as to whether the probability is high or low may be made by comparing the probability with a predetermined threshold. The display control module 115 may adjust how quickly the presentation mode will be changed, that is, it may adjust the switching speed of the presentation mode, in accordance with the probability. For example, if the probability is high, the switching speed of the presentation mode may be increased, and if the probability is low, the switching speed of the presentation mode may be decreased.

Changing of the presentation mode may be implemented by changing of the color, configuration (such as the frame thickness), or design of a document itself or a frame for displaying the document (also called a window frame), changing (including addition and deletion) of a character string (message), drawings, and symbols, making dynamic change (using flash and animated graphics, for example), blinking, generating sound (including synthesized sound and music) or vibrations, and a combination thereof. In the case of blinking, changing of the presentation mode may be represented by whether blinking is performed or by the blinking period or the interval of blinking.

No change may be made to a document itself so as not to disturb a user reading the document, though the user is still informed of the possibility of unauthorized access by the third party. In this case, instead of the document itself, the frame for displaying the document may be changed, or sound may be generated.

When access to a document is restricted to only particular users, the display control module 115 may change the presentation mode of this document. When access to a document is not restricted to particular users, such as in the case of an Internet homepage that anyone can access, the display control module 115 may not change the presentation mode of this document.

If restrictions regarding users authorized to access a document are set for each document or each folder including such a document, a group of authorized users (for example, only executive officers) or an access right set in a document or a file may be used to determine whether the presentation mode will be changed. If restrictions are set in a folder, all the documents included in this folder are subjected to such restrictions.

The display control module 115 may change the presentation mode of a document in accordance with the time for which the document is being presented. For example, the display control module 115 may change the presentation mode of a document in accordance with the probability calculated by the calculation module 110 by using the time for which the document is being presented.

For example, the color of a frame of a document may be changed to green, yellow, and red in this order as the presentation time for the document becomes longer. In this example, as in the colors of traffic lights, switching of the color among green, yellow, and red in this order indicates increasing of the security risk.

The time for which a document is being presented may be: (1) the time from when the document has opened until the current time; (2) the time for which no operation is performed on a terminal displaying the document within the time (1); or (3) the time for which no operation is performed on the document within the time (1).

The display control module 115 may adjust the switching speed of the presentation mode in accordance with the degree of restrictions regarding users authorized to access a document. For example, the display control module 115 may adjust the switching speed of the presentation mode in accordance with the probability calculated by the calculation module 110 by using the above-described degree of restrictions regarding authorized users.

The degrees of restrictions regarding users authorized to access a document are determined in the following manner, for example. If authorized users are restricted to executive officers or higher positions, the degree of restrictions is level 3. If authorized users are restricted to department chiefs or higher positions, the degree of restrictions is level 2. If authorized users are restricted to section chiefs or higher positions, the degree of restrictions is level 1. The degrees of restrictions will be discussed later by using a disclosure range table 1900 shown in FIG. 19.

If the degree of restrictions is high, the display control module 115 may increase the switching speed of the presentation mode.

Conversely, if the degree of restrictions is low, the display control module 115 may decrease the switching speed of the presentation mode or maintain the initial speed.

The display control module 115 may determine whether the degree of restrictions is high or low by comparing the degree with a predetermined threshold. In the above-described example, if the degree of restrictions is level 2 or level 3, the display control module 115 determines that the degree of restrictions is high. If the degree of restrictions is level 3, the display control module 115 determines that the degree of restrictions is very high, and changes the presentation mode most quickly.

The display control module 115 may adjust the switching speed of the presentation mode in accordance with the location where a document is accessed. For example, the display control module 115 may adjust the switching speed of the presentation mode in accordance with the probability calculated by the calculation module 110 by using the location where a document is accessed.

The location where a document is accessed is a location at which a display displaying the document is positioned. However, the location where a document is accessed may be a location at which one of mobile information processing apparatuses 200 and 210 and a document management apparatus 250, which will be discussed later, is positioned.

If the security of the location where a document is accessed is low, the display control module 115 may increase the switching speed of the presentation mode.

Conversely, if the security of the location where a document is accessed is high, the display control module 115 may decrease the switching speed of the presentation mode or maintain the initial speed.

A determination as to whether the security of the location where a document is accessed is low may be made in the following manner. A list of locations where the security is low, such as station yards and parks, and a table in which position information and various facilities, such as station yards and parks, are associated with each other are prepared in advance. Then, based on position information output from a global positioning system (GPS) installed in the mobile information processing apparatus 200, for example, the display control module 115 extracts the facility in which the mobile information processing apparatus 200 is positioned by using the table, and determines whether the facility is included in the list. If the facility is included in the list, the display control module 115 determines that the security of the location is low. Alternatively, a list of locations where the security is high, such as offices and private rooms, and a table in which position information and various facilities are associated with each other are prepared in advance. Then, based on position information output from the GPS installed in the mobile information processing apparatus 200, for example, the display control module 115 extracts the facility in which the mobile information processing apparatus 200 is positioned by using the table, and determines whether the facility is included in the list. If the facility is not included in the list, the display control module 115 determines that the security of the location is low.

The display control module 115 may adjust the switching speed of the presentation mode in accordance with the security state of a terminal (such as mobile information processing apparatuses 200 and 210 and a document management apparatus 250) displaying a document. For example, the display control module 115 may adjust the switching speed of the presentation mode in accordance with the probability calculated by the calculation module 110 by using the security state of a terminal.

The security state may be determined, for example, from the version of an operating system (OS) and whether antivirus software or security software is installed and whether required patches are applied to a terminal.

If the security state of a terminal is not a sufficient level, the display control module 115 may increase the switching speed of the presentation mode.

Conversely, if the security state is a sufficient level, the display control module 115 may decrease the switching speed of the presentation mode or maintain the initial speed.

The display control module 115 may adjust the switching speed of the presentation mode in accordance with the angle of a screen displaying a document. For example, the display control module 115 may adjust the switching speed of the presentation mode in accordance with the probability calculated by the calculation module 110 by using the angle of a screen displaying a document.

If the screen is positioned at an angle at which a document is viewable by another user, the display control module 115 may increase the switching speed of the presentation mode.

Conversely, if the screen is positioned at an angle at which a document is not viewable by another user, the display control module 115 may decrease the switching speed of the presentation mode or maintain the initial speed.

For example, when the screen displaying a document is a screen of a mobile terminal, such as a tablet terminal or a notebook personal computer (PC), if the screen is positioned horizontally, the document is viewable by another user. If the screen of the mobile terminal is tilted, the display control module 115 determines that the screen is not viewable by another user and decreases the switching speed of the presentation mode. When the screen displaying a document is a desktop PC, it is usually positioned vertically. In this case, the display control module 115 increases the switching speed of the presentation mode. If the angle of the screen with respect to the horizontal position is greater than a threshold (30 degrees, for example), it may be determined that the screen is tilted.

If a sensor of a terminal, such as a vibration sensor, is sensing small motion or if the sensor is sensing that the mobile information processing apparatus 200, for example, is held by a user, the display control module 115 may determine that the screen is not viewable by another user. If the angle of the screen with respect to the horizontal position is within the threshold and if the sensor is sensing small motion, the display control module 115 may determine that the screen is not viewable by another user.

The display control module 115 may adjust the switching speed of the presentation mode in accordance with whether an operation is performed on a document. For example, the display control module 115 may adjust the switching speed of the presentation mode in accordance with the probability calculated by the calculation module 110 according to whether an operation is performed on a document.

If no operation is performed on a document, the display control module 115 may increase the switching speed of the presentation mode.

Conversely, if an operation is performed on a document, the display control module 115 may decrease the switching speed of the presentation mode or maintain the initial speed.

The display control module 115 may adjust the switching speed of the presentation mode in accordance with the type of operation performed on a document. For example, the display control module 115 may adjust the switching speed of the presentation mode in accordance with the probability calculated by the calculation module 110 by using the type of operation performed on a document.

When the screen displaying a document is a touchscreen, if the type of operation is an operation performed on the touchscreen by using a finger or a pen, the display control module 115 may decrease the switching speed of the presentation mode or maintain the initial speed. This is because a finger or a pen on the screen can prevent another user from looking at the screen. A determination as to whether the screen is a touchscreen may be made from configuration information concerning a terminal, such as the mobile information processing apparatus 200. This determination may alternatively be made by judging whether the screen is a tablet terminal. An operation other than that on a touchscreen may be an operation performed on a button disposed on a side of the mobile information processing apparatus 200 or an operation using voice recognition, such as a voice instruction.

When the screen displaying a document is a touchscreen, if the type of operation is not an operation using a finger or a pen, the display control module 115 may increase the switching speed of the presentation mode.

If the type of operation is an enlargement operation, the display control module 115 may increase the switching speed of the presentation mode because another user can read a document more easily if the document is enlarged.

Conversely, if the type of operation is a reduction operation, the display control module 115 may decrease the switching speed of the presentation mode or maintain the initial speed.

The display control module 115 may adjust the switching speed of the presentation mode in accordance with the time and date (year, month, day, hour, minute, second, millisecond, or a combination thereof) at and on which a document is displayed. For example, the display control module 115 may adjust the switching speed of the presentation mode in accordance with the probability calculated by the calculation module 110 by using the time and date at and on which a document is displayed.

If the time and date at and on which a document is displayed is during non-business hours, such as 17:00 to 9:00, the display control module 115 may increase the switching speed of the presentation mode.

Conversely, if the time and date at and on which a document is displayed is during business hours, such as 9:00 to 17:00, the display control module 115 may decrease the switching speed of the presentation mode or maintain the initial speed.

If a document is set to be unavailable for access and is then set to be available for access again, the display control module 115 may adjust the switching speed of the presentation mode in accordance with the time for which the document has been unavailable (will also be called the document unavailable time). For example, the display control module 115 may adjust the switching speed of the presentation mode in accordance with the probability calculated by the calculation module 110 by using the document unavailable time. That is, if a document is set to be unavailable for access and is then displayed again in a state in which it is available, the display control module 115 changes the presentation mode of the document to that in which the document has been displayed before it becomes unavailable. If the document unavailable time exceeds a threshold, the display control module 115 changes the presentation mode of the document to that in which the document has been displayed for the first time, that is, in the initial presentation mode, rather than that immediately before the document becomes unavailable.

A document becomes unavailable for access after performing following operations: closing the document (closing a window opening the document, for example); shutting down a device, such as a PC, presenting the document; and setting the document in a non-active state, such as minimizing a window opening the document and opening another window over the window opening the document.

The display control module 115 may change the presentation mode of a document as a result of comparing the document unavailable time with a threshold determined by using a screen lock start time.

The screen lock start time is a time from when the latest operation is performed on a terminal displaying a document until when the screen of the terminal is locked. The screen lock start time is individually set for each terminal. After the lapse of the screen lock start time, the screen is switched to a lock screen, and the screen displayed before it has switched to the lock screen, that is, the displayed document, becomes invisible, and the terminal is not possible to operate. To restart the terminal, a user is required to unlock the lock screen by inputting a password, for example.

As the threshold, a time longer than the screen lock start time is set. If the document unavailable time is shorter than or shorter than or equal to the threshold, the display control module 115 may change the presentation mode of the document.

The display module 120 is connected to the control module 105. The display module 120 displays a document on a display, such as a liquid crystal display. When a document that only an authorized user can open is displayed, the display module 120 changes the presentation mode of the document under the control of the display control module 115.

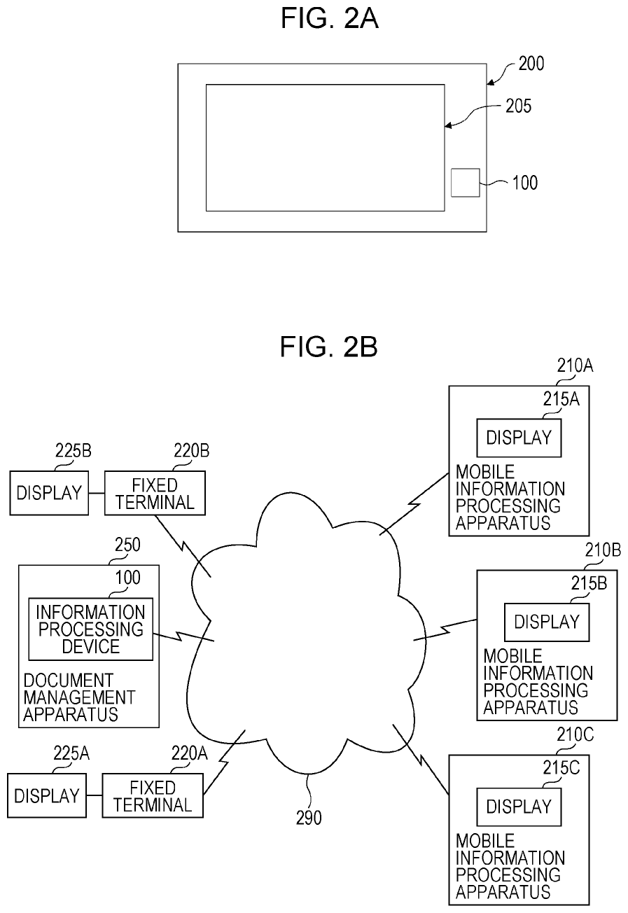

FIGS. 2A and 2B illustrate examples of the system configuration utilizing the exemplary embodiment.

FIG. 2A illustrates an example of the system configuration of a standalone type.

A mobile information processing apparatus 200 includes the information processing device 100 and a display 205. The mobile information processing apparatus 200 displays a document on the display 205 under the control of the information processing device 100.

FIG. 2B illustrates an example of the system configuration of a network type.

Mobile information processing apparatuses 210A, 210B, and 210C include displays 215A, 215B, and 215C, respectively. Hereinafter, the mobile information processing apparatuses 210A, 210B, and 210C will collectively be called the mobile information processing apparatus 210 unless it is necessary to distinguish them from each other. The displays 215A, 215B, and 215C will collectively be called the display 215, unless it is necessary to distinguish them from each other.

Fixed terminals 220A and 220B are connected to displays 225A and 225B, respectively. Hereinafter, the fixed terminals 220A and 220B will collectively be called the terminal 210 unless it is necessary to distinguish them from each other.

A document management apparatus 250 includes the information processing device 100.

The mobile information processing apparatuses 210A, 210B, and 210C, the fixed terminals 220A and 220B, and the information processing device 100 of the document management apparatus 250 are connected to each other via a communication line 290. The communication line 290 may be a wireless or wired medium, or a combination thereof, and may be, for example, the Internet or an intranet as a communication infrastructure. The functions of the information processing device 100 may be implemented as cloud services. Under the control of the information processing device 100, documents are displayed on the display 215 of the mobile information processing apparatus 210 and the display 225 of the fixed terminal 220.

If a user continues reading a document by using the mobile information processing apparatus 200, for example, the risk of information leakage (possibility that another user will physically look at the document) is increased. In particular, if the user keeps the document open, the opportunity for the third party to read the document is increased.

To deal with this issue, as the time for a document is being presented is becoming long, the information processing device 100 of this exemplary embodiment changes the presentation mode of the document so as to inform a user that the risk of information leakage is increasing.

An example in which the color of a window frame displaying a document is changed will be discussed below.

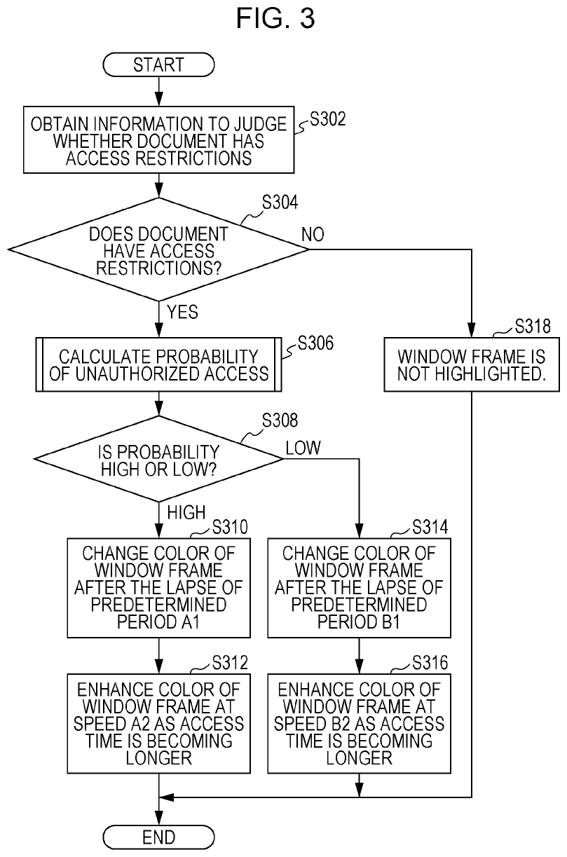

FIG. 3 is a flowchart illustrating an example of processing executed in the exemplary embodiment.

In step S302, the information processing device 100 obtains information to be used for judging whether a subject document has access restrictions. The information processing device 100 obtains attributes (such as access rights) of this document, for example.

In step S304, the information processing device 100 judges whether the subject document has access restrictions. If the document has access restrictions, the process proceeds to step S306. If the document does not have access restrictions, the process proceeds to step S318.

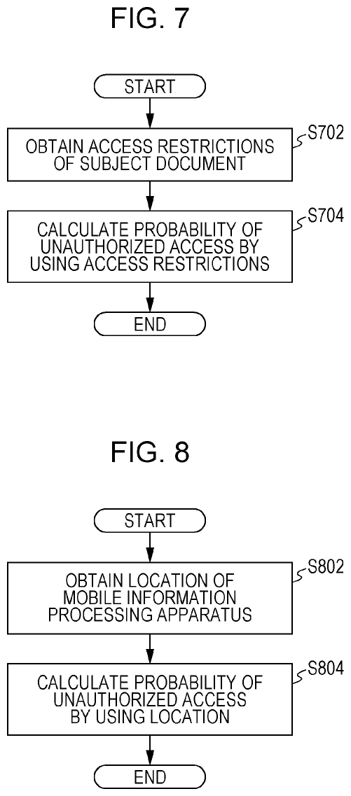

In step S306, the information processing device 100 calculates the probability of unauthorized access. Details of step S306 will be discussed later with reference to the flowcharts of FIGS. 7 through 14.

In step S308, the information processing device 10 judges whether the probability is high or low as a result of comparing the calculated probability with a predetermined threshold, for example. If the probability is high, the process proceeds to step S310. If the probability is low, the process proceeds to step S314.

In step S310, the information processing device 100 changes the color of the window frame after the lapse of a predetermined period A1.

In step S312, the information processing device 100 enhances the color of the window frame at a speed A2 as the access time is becoming longer.

In step S314, the information processing device 100 changes the color of the window frame after the lapse of a predetermined period B1. The period A1 is shorter than the period B1.

In step S316, the information processing device 100 enhances the color of the window frame at a speed B2 as the access time is becoming longer. The speed A2 is faster than the speed B2.

In step S318, the window frame is not highlighted. In the flowchart of FIG. 3, two options of the speed, that is, the speed A2 and the speed B2, are used as the switching speed of the presentation mode (may also be called the enhancement speed). However, three or more options may be used as the switching speed of the presentation mode.

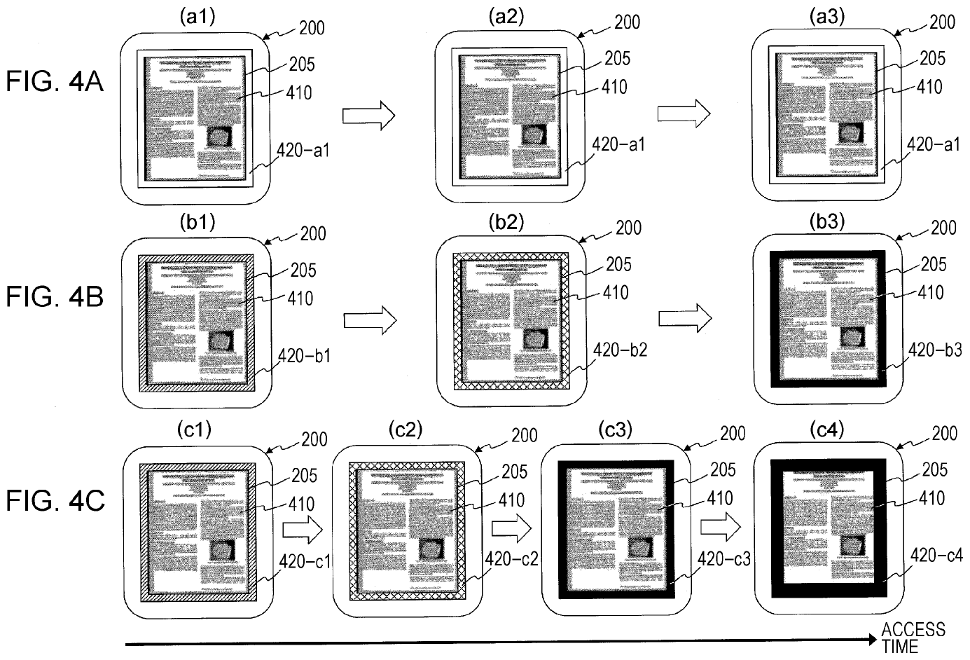

FIGS. 4A through 4C illustrate an example of processing executed in the exemplary embodiment.

A document 410 is displayed on the display 205 of the mobile information processing apparatus 200. The presentation mode of the document 410 is changed as the access time is becoming longer.

FIG. 4A illustrates an example of a change in the presentation mode of a document 410 when the document 410 does not have any access restrictions (steps S304 through S318). Even though the access time is becoming longer, the color of the window frame of the document 410 does not change, such as a window frame 420-a1 (white) indicated by (a1), a window frame 420-a1 (white) indicated by (a2), and a window frame 420-a1 (white) indicated by (a3).

FIG. 4B illustrates an example of a change in the presentation mode of a document 410 when the document 410 has access restrictions and the probability of unauthorized access is low (steps S304 through S316). A window frame 420-b1 in the initial presentation mode is displayed in green, as indicated by (b1), and as the access time is becoming longer, the window frame 420-b1 is switched to a window frame 420-b2 in yellow, as indicated by (b2), and is further switched to a window frame 420-b3 in red, as indicated by (b3).

FIG. 4C illustrates an example of a change in the presentation mode of a document 410 when the document 410 has access restrictions and the probability of unauthorized access is high (steps S304 through S312). A window frame 420-c1 in the initial presentation mode is displayed in green, as indicated by (c1), and as the access time is becoming longer, the window frame 420-c1 is switched to a window frame 420-c2 in yellow, as indicated by (c2), and is then switched to a window frame 420-c3 in red, as indicated by (c3), and is further switched to a thicker window frame 420-c4 in red, as indicated by (c4). The switching speed of the presentation mode in FIG. 4C is faster than that in FIG. 4B.

In the case of FIG. 4B, the color of the window frame in the initial presentation mode may be white, as in the window frame 420-a1 in FIG. 4A, and after the lapse of the period B1, the window frame 420-a1 may be switched to the window frame 420-b1 in green. In the case of FIG. 4C, the color of the window frame in the initial presentation mode may be white, as in the window frame 420-a1 in FIG. 4A, and after the lapse of the period A1, which is shorter than the period B1, the window frame 420-a1 may be switched to the window frame 420-c1 in green.

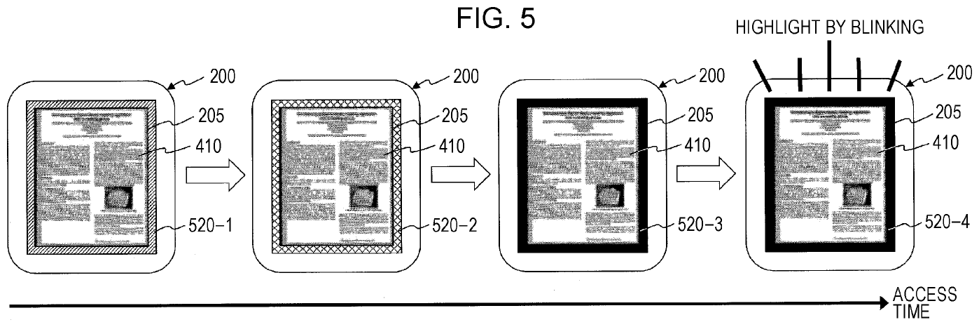

FIG. 5 illustrates an example of processing executed in the exemplary embodiment.

In the example of FIGS. 4A through 4C, as the access time is becoming longer, the colors (green, yellow, and red) or the thickness of the window frame are changed. Instead of the color or the thickness of a window frame, the window frame may be caused to blink.

FIG. 5 illustrates an example of a change in the presentation mode of a document 410 when the document 410 has access restrictions and the probability of unauthorized access is high (steps S304 through 5312). A window frame 520-1 in the initial presentation mode is displayed in green, and as the access time is becoming longer, the window frame 520-1 is switched to a window frame 520-2 in yellow, and is then switched to a window frame 520-3 in red, and is further switched to a window frame 520-4 in red and also blinking. Causing the window frame 520-4 to blink can inform a user that the possibility of unauthorized access is increasing.

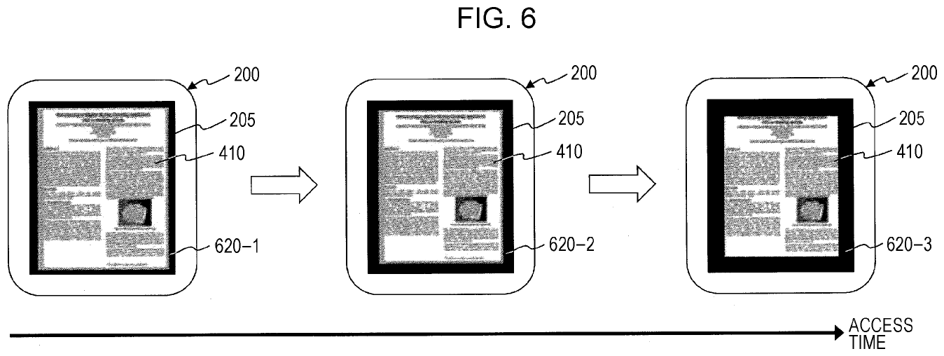

FIG. 6 illustrates an example of processing executed in the exemplary embodiment.

As the access time is becoming longer, the thickness of a window frame may be changed while the color of the window frame is fixed (in red, for example).

FIG. 6 illustrates an example of a change in the presentation mode of a document 410 when the document 410 has access restrictions and the probability of unauthorized access is high (steps S304 through S312). A window frame 620-1 in the initial presentation mode is thin and red, and as the access time is becoming longer, the window frame 620-1 is switched to a thicker window frame 620-2 in red, and is then switched to an even thicker window frame 620-3 in red. Making the window frame thicker can inform a user that the possibility of unauthorized access is increasing.

The color, thickness, and blinking state of a window frame may be combined to change the presentation mode of a document. Alternatively, as discussed above, the design of a window frame may be changed, or a message, animation, sound, or vibration may be generated within the window frame.

FIG. 7 is a flowchart illustrating an example of processing executed in the exemplary embodiment.

In step S702, the information processing device 100 obtains access restrictions of a subject document.

In step S704, the information processing device 100 calculates the probability of unauthorized access by using the access restrictions.

In this processing, the switching speed of the presentation mode is adjusted in accordance with the degree of access restrictions of a document. If the degree of access restrictions is high, the switching speed of the presentation mode is increased.

For example, the disclosure range table 1900 shown in FIG. 19 may be used. FIG. 19 illustrates an example of the data structure of the disclosure range table 1900. The disclosure range table 1900 includes a disclosure range field 1910 and a security level field 1920. The disclosure range field 1910 indicates a disclosure range, and the security level field 1920 indicates a security level corresponding to the disclosure range.

If the disclosure range is restricted to executive officers or higher positions, the security level is 3. If the disclosure range is restricted to department chiefs or higher positions, the security level is 2. If the disclosure range is restricted to section chiefs or higher positions, the security level is 1. If the security level is 2 or 3, the probability of unauthorized access may be set to be high or to a value indicating a high probability. In this case, if the security level is 1, the probability of unauthorized access is set to be low or to a value indicating a low probability.

FIG. 8 is a flowchart illustrating an example of processing executed in the exemplary embodiment.

In step S802, the information processing device 100 obtains the location of the mobile information processing apparatus 200 on which a document is displayed. For example, as discussed above, the information processing device 100 may obtain position information from the GPS installed in the mobile information processing apparatus 200.

In step S804, the information processing device 100 calculates the probability of unauthorized access by using the location obtained in step S802.

In this processing, the switching speed of the presentation mode is adjusted in accordance with the location at which a document is accessed. If the security of the location is low, such as in a station yard, the switching speed of the presentation mode is increased.

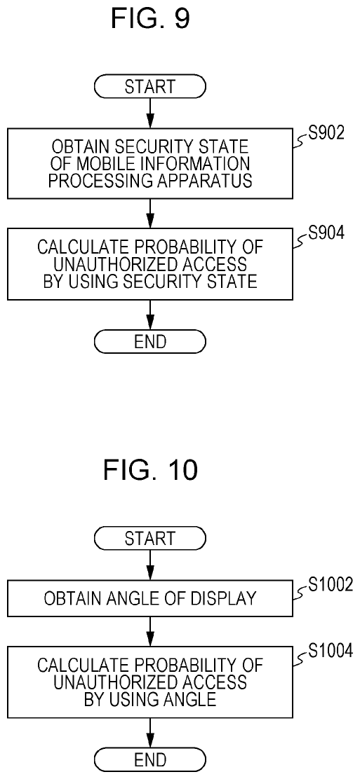

FIG. 9 is a flowchart illustrating an example of processing executed in the exemplary embodiment.

In step S902, the information processing device 100 obtains the security state of the mobile information processing apparatus 200.

In step S904, the information processing device 100 calculates the probability of unauthorized access by using the security state.

In this processing, the switching speed of the presentation mode is adjusted in accordance with the security state of a terminal displaying a document. If the security state of the terminal is not a sufficient level, such as if required patches are not applied to this terminal, the switching speed of the presentation mode is increased.

FIG. 10 is a flowchart illustrating an example of processing executed in the exemplary embodiment.

In step S1002, the information processing device 100 obtains the angle of the display 205.

In step S1004, the information processing device 100 calculates the probability of unauthorized access by using the angle.

In this processing, the switching speed of the presentation mode is adjusted in accordance with the angle of a screen displaying a document. If the screen is positioned at an angle at which a document is viewable by another user, such as if a tablet terminal is positioned horizontally, the switching speed of the presentation mode is increased.

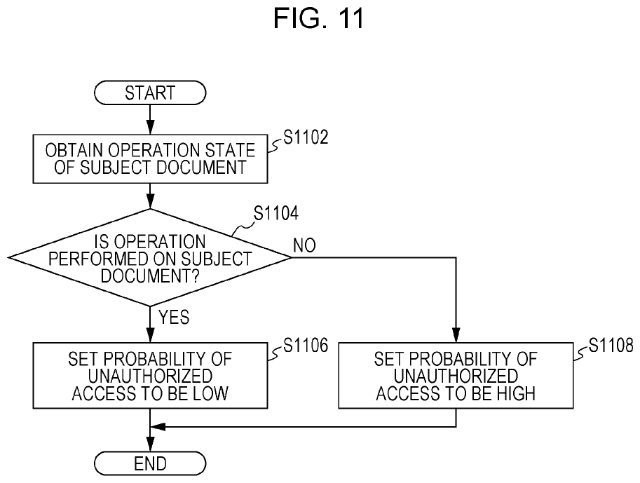

FIG. 11 is a flowchart illustrating an example of processing executed in the exemplary embodiment.

In step S1102, the information processing device 100 obtains the operation state of a subject document.

In step S1104, the information processing device 100 judges whether an operation is performed on the subject document. If an operation is performed, the process proceeds to step S1106. If no operation is performed, the process proceeds to step S1108.

In step S1106, the information processing device 100 sets the probability of unauthorized access to be low.

In step S1108, the information processing device 100 sets the probability of unauthorized access to be high.

In this processing, the switching speed of the presentation mode is adjusted according to whether an operation is performed on a document. If no operation is performed on the document, the switching speed of the presentation mode is increased.

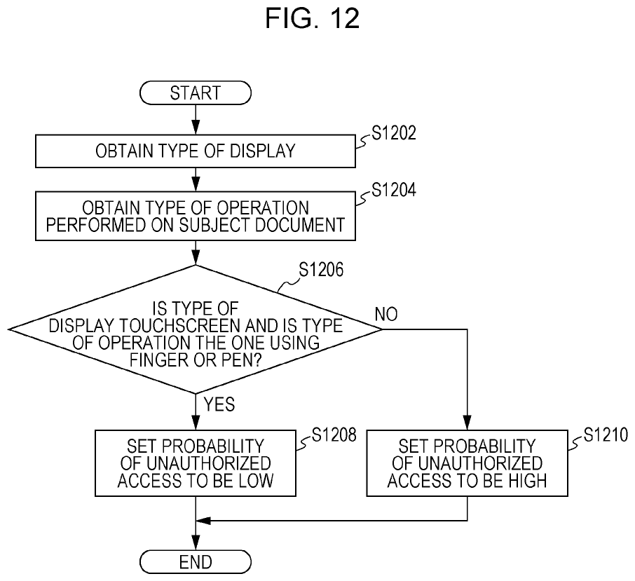

FIG. 12 is a flowchart illustrating an example of processing executed in the exemplary embodiment.

In step S1202, the information processing device 100 obtains the type of display.

In step S1204, the information processing device 100 obtains the type of operation performed on a subject document.

In step S1206, the information processing device 100 judges whether the type of display is a touchscreen and whether the type of operation is an operation using a finger or a pen. If the type of display is a touchscreen and if the type of operation is an operation using a finger or a pen, the process proceeds to step S1208. If the type of display is not a touchscreen or if the type of operation is not an operation with a finger or a pen, the process proceeds to step S1210.

In step S1208, the information processing device 100 sets the probability of unauthorized access to be low.

In step S1210, the information processing device 100 sets the probability of unauthorized access to be high.

In this processing, the switching speed of the presentation mode is adjusted in accordance with the type of operation performed on a document. If the screen displaying a document is a touchscreen and if the type of operation is an operation using a finger or a pen, the switching speed of the presentation mode is decreased or is maintained at the initial speed.

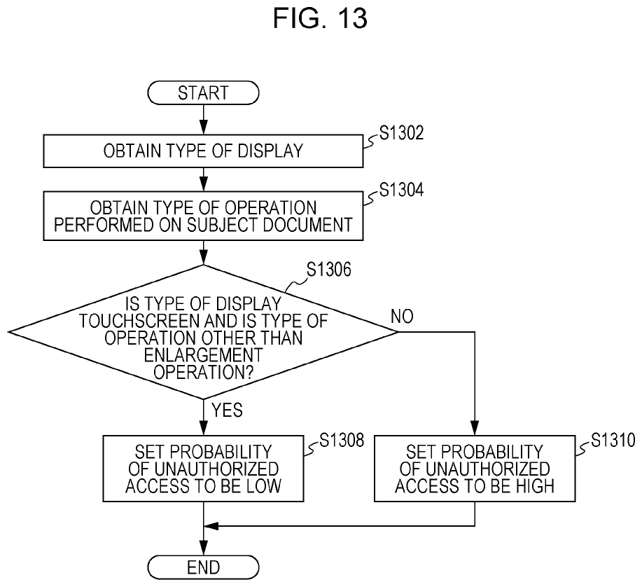

FIG. 13 is a flowchart illustrating an example of processing executed in the exemplary embodiment.

In step S1302, the information processing device 100 obtains the type of display.

In step S1304, the information processing device 100 obtains the type of operation performed on a subject document.

In step S1306, the information processing device 100 judges whether the type of display is a touchscreen and whether the type of operation is an operation other than an enlargement operation. If the type of display is a touchscreen and if the type of operation is not an enlargement operation, the process proceeds to step S1308. If the type of display is not a touchscreen or if the type operation is an enlargement operation, the process proceeds to step S1310.

In step S1308, the information processing device 100 sets the probability of unauthorized access to be low.

In step S1310, the information processing device 100 sets the probability of unauthorized access to be high.

In this processing, the switching speed of the presentation mode is adjusted in accordance with the type of operation performed on a document. If the type of operation is an enlargement operation, the switching speed of the presentation mode is increased. Conversely, if the type of operation is a reduction operation, the switching speed of the presentation mode may be decreased.

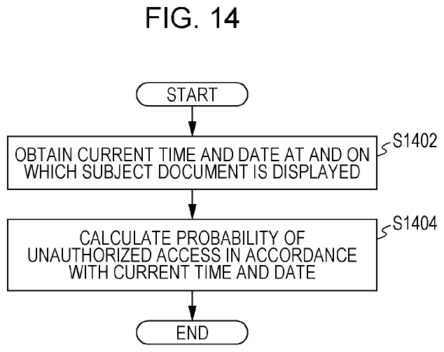

FIG. 14 is a flowchart illustrating an example of processing executed in the exemplary embodiment.

In step S1402, the information processing device 100 obtains the current time and date at and on which a subject document is displayed.

In step S1404, the information processing device 100 calculates the probability of unauthorized access in accordance with the current time and date.

In this processing, the switching speed of the presentation mode is adjusted in accordance with the time and date at and on which a document is displayed. If the time and date is during non-business hours, the switching speed of the presentation mode is increased.

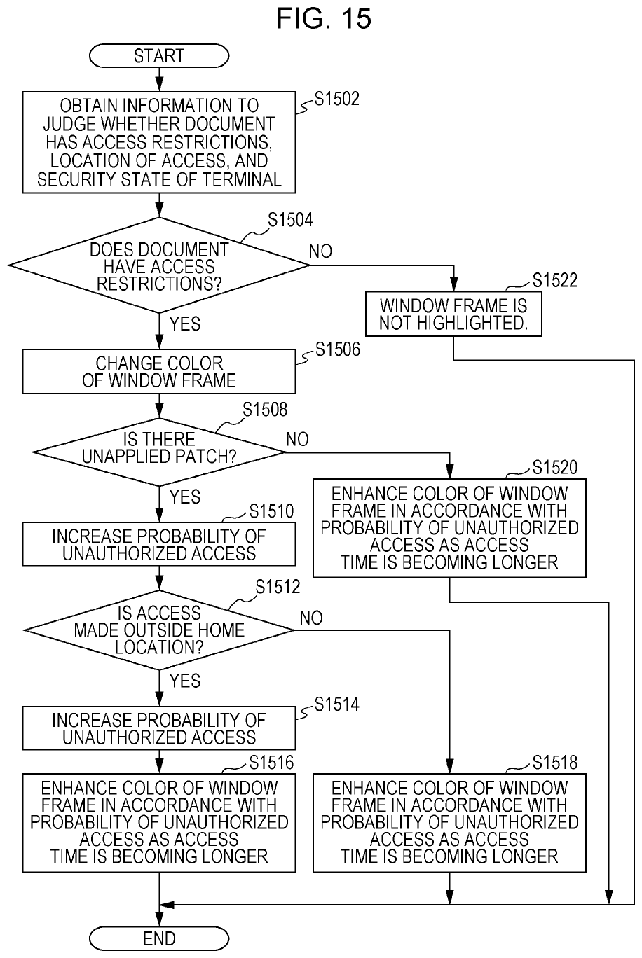

FIG. 15 is a flowchart illustrating an example of processing executed in the exemplary embodiment. More specifically, FIG. 15 illustrates a specific example of processing for adjusting the switching speed of the presentation mode by using both of the location of access and the security state of a terminal.

In step S1502, the information processing device 100 obtains information to be used for judging whether a subject document has access restrictions, the location of document access, and the security state of a terminal.

In step S1504, the information processing device 100 judges whether the subject document has access restrictions. If the document has access restrictions, the process proceeds to step S1506. If the document does not have access restrictions, the process proceeds to step S1522.

In step S1506, the information processing device 100 changes the color of the window frame displaying the document.

In step S1508, the information processing device 100 judges whether there is a patch that has not been applied to the terminal. If there is an unapplied patch, the process proceeds to step S1510. If there is no unapplied patch, the process proceeds to step S1520.

In step S1510, the information processing device 100 increases the probability of unauthorized access.

In step S1512, the information processing device 100 judges whether a user is accessing the subject document outside the home location (the location of an organization, for example). If the user is accessing the document outside the home location, the process proceeds to step S1514. If the user is accessing the document within the home location, the process proceeds to step S1518.

In step S1514, the information processing device 100 increases the probability of unauthorized access.

In step S1516, as the access time is becoming longer, the information processing device 100 enhances the color of the window frame in accordance with the probability of unauthorized access.

In step S1518, as the access time is becoming longer, the information processing device 100 enhances the color of the window frame in accordance with the probability of unauthorized access.

In step S1520, as the access time is becoming longer, the information processing device 100 enhances the color of the window frame in accordance with the probability of unauthorized access.

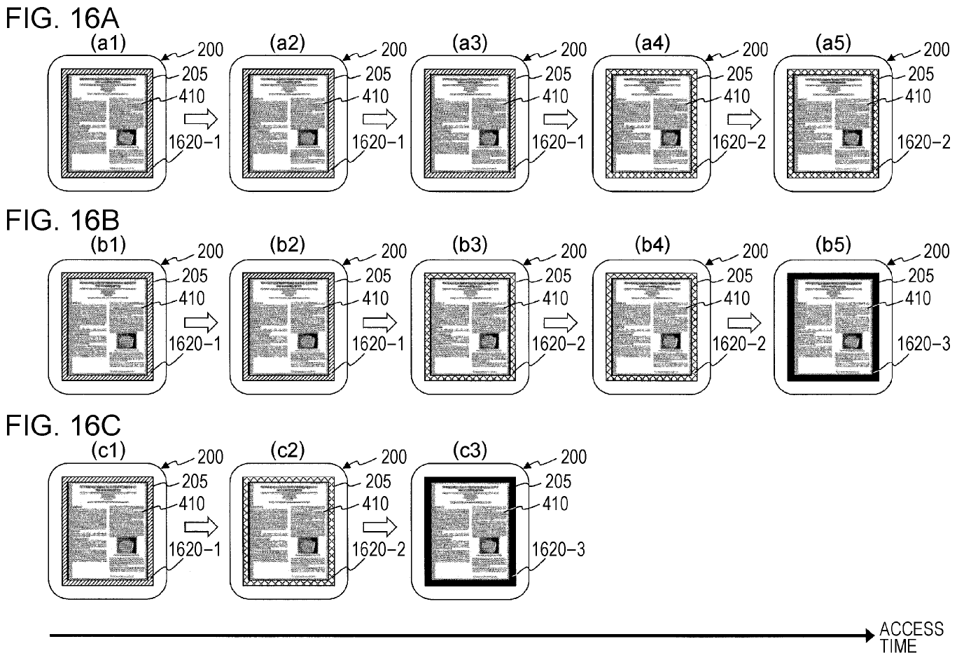

In step S1522, the window frame is not highlighted. FIGS. 16A through 16C illustrate an example of processing executed in the exemplary embodiment. More specifically, FIGS. 16A through 16C illustrate examples of a change in the presentation mode of a document displayed on the mobile information processing apparatus 200 according to the processing of the flowchart of FIG. 15.

FIG. 16A illustrates an example of a change in the presentation mode of a document 410 when the document 410 has access restrictions and there is no unapplied patch (steps S1504 through S1520).

A window frame 1620-1 in the initial presentation mode is displayed in green, as indicated by (a1), and is switched to a window frame 1620-2 in yellow, as indicated by (a4).

FIG. 16B illustrates an example of a change in the presentation mode of a document 410 when the document 410 has access restrictions, there is an unapplied patch, and the location of access is within the home location (steps S1504 through S1518).

The probability of unauthorized access is increased one time in step S1510. The color of the window frame 1620-1 is changed earlier than in the example in FIG. 16A.

More specifically, a window frame 1620-1 in the initial presentation mode is displayed in green, as indicated by (b1), and is switched to a window frame 1620-2 in yellow, as indicated by (b3), and is further switched to a window frame 1620-3 in red, as indicated by (b5).

FIG. 16C illustrates an example of a change in the presentation mode of a document 410 when the document 410 has access restrictions, there is an unapplied patch, and the location of access is outside the home location (steps S1504 through S1516).

The probability of unauthorized access is increased two times in steps S1510 and 51514. The color of the window frame 1620-1 is changed earlier than in the example in FIG. 16B.

More specifically, a window frame 1620-1 in the initial presentation mode is displayed in green, as indicated by (c1), and is switched to a window frame 1620-2 in yellow, as indicated by (c2), and is further switched to a window frame 1620-3 in red, as indicated by (c3).

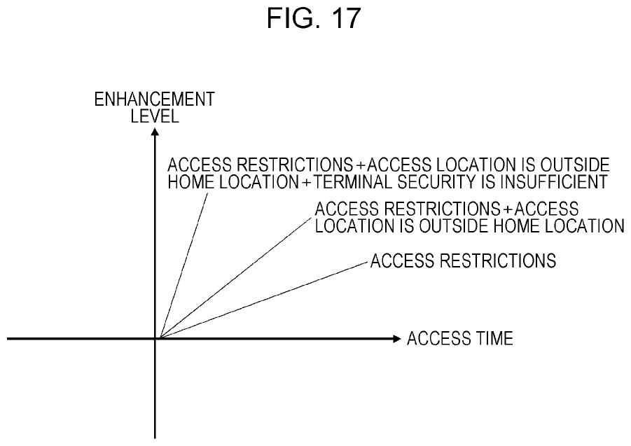

FIG. 17 illustrates examples of the switching speed of the display mode according to the exemplary embodiment.

FIG. 17 illustrates a graph having the access time on the horizontal axis and the enhancement level (steps in which the color of a window frame is changed, for example) on the vertical axis. The slope of the graph represents the switching speed of the display mode. That is, as the risk of information leakage is higher, the degree by which the enhancement level changes is greater. Although the access restrictions and the security state of a terminal are each represented by two values (0 or 1) in the above-described example, they may be represented in greater details in accordance with the level of access restrictions and that of the security state.

In a case in which a document has access restrictions, the location of access is outside the home location, and the security of a terminal is not sufficient (with an unapplied patch), the switching speed of the display mode is the highest.

In a case in which a document has access restrictions, the location of access is within the home location, and the security of a terminal is sufficient (no unapplied patch), the switching speed of the display mode is the lowest.

In a case in which a document has access restrictions, the location of access is outside the home location, and the terminal security is sufficient, the switching speed of the display mode is between the speeds of the above-described two cases.

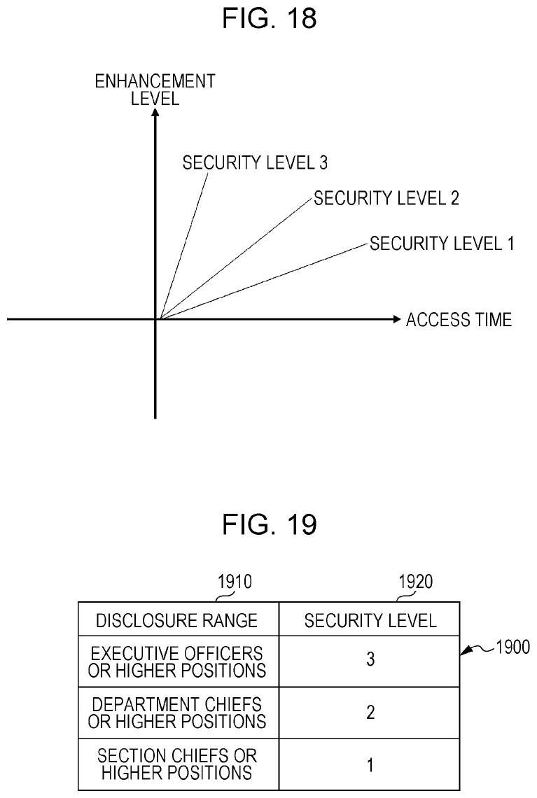

FIG. 18 illustrates examples of the switching speed of the display mode according to the exemplary embodiment.

As in FIG. 17, FIG. 18 illustrates a graph having the access time on the horizontal axis and the enhancement level (steps in which the color of a window frame is changed, for example) on the vertical axis. The slope of the graph represents the switching speed of the display mode.

In this example, the switching speed of the display mode is determined in accordance with the degree of restrictions regarding users authorized to access a document.

When the security level is 3 (authorized users are restricted to executive officers or higher positions), the switching speed of the display mode is the highest.

When the security level is 1 (authorized users are restricted to section chiefs or higher positions), the switching speed of the display mode is the lowest.

When the security level is 2 (authorized users are restricted to department chiefs or higher positions), the switching speed of the display mode is between the speeds of the above-described two cases.

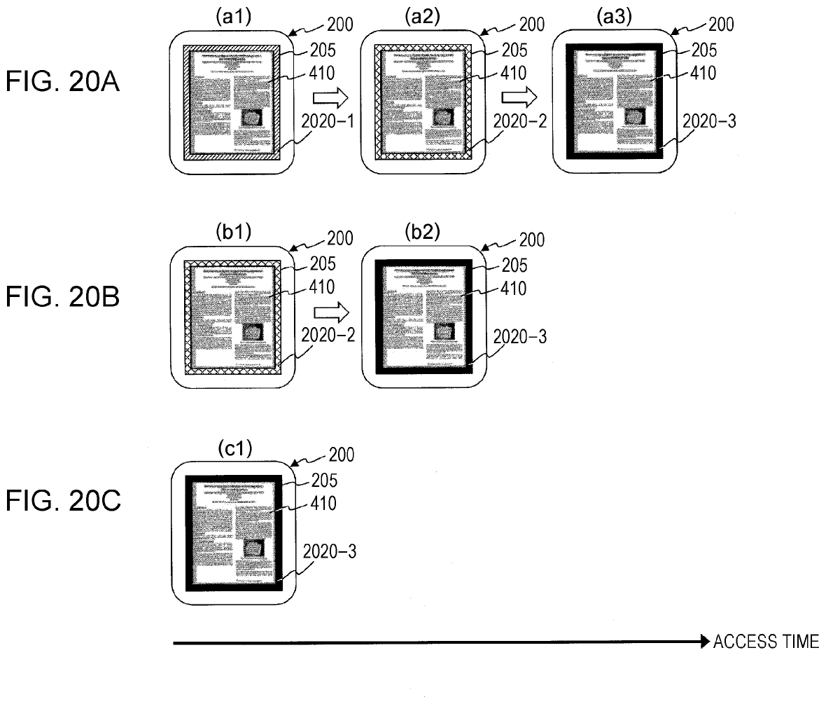

FIGS. 20A through 20C illustrate an example of processing executed in the exemplary embodiment. More specifically, FIGS. 20B and 20C illustrate examples in which the color of the window frame displaying a document in the initial presentation mode is already changed.

FIG. 20A illustrates an example of a change in the presentation mode of a document 410 when the document 410 has access restrictions, the location of access is within the home location, and the security of a terminal is sufficient (no unapplied patch). A window frame 2020-1 in the initial presentation mode is displayed in green, as indicated by (a1), and is switched to a window frame 2020-2 in yellow, as indicated by (a2), and is further switched to a window frame 2020-3 in red, as indicated by (a3).

FIG. 20B illustrates an example of a change in the presentation mode of a document 410 when the document 410 has access restrictions, the location of access is within the home location, and the security of a terminal is not sufficient (with an unapplied patch). A window frame 2020-2 of the document 410 in the initial presentation mode is already in yellow instead of in green, as indicated by (b1) and is switched to a window frame 2020-3 in red, as indicated by (b2).

FIG. 20C illustrates an example of a change in the presentation mode of a document 410 when the document 410 has access restrictions, the location of access is outside the home location, and the security of a terminal is not sufficient (with an unapplied patch). A window frame 2020-3 of the document 410 in the initial presentation mode is already in red instead of in green or yellow, as indicated by (c1).

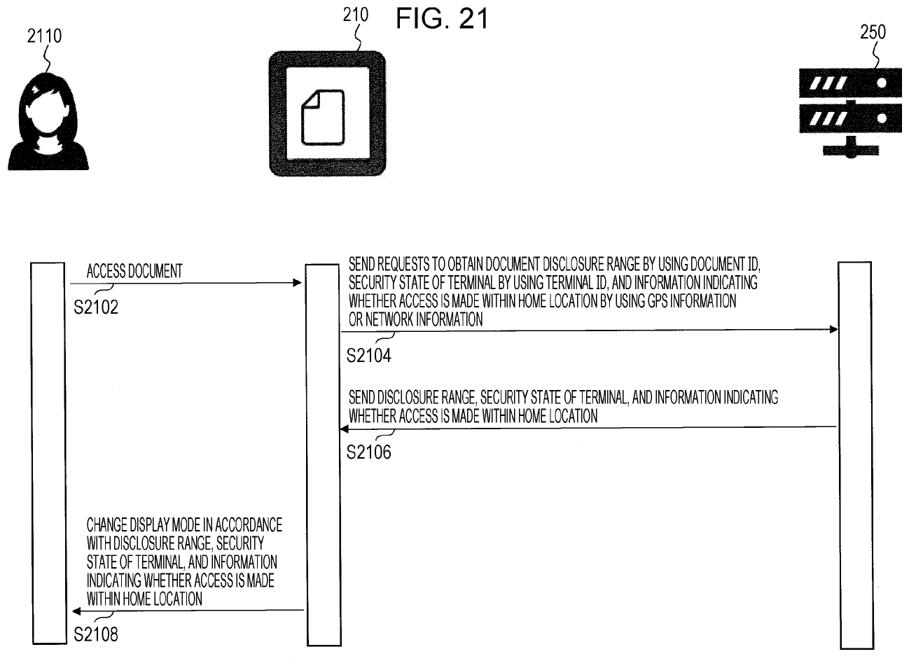

FIG. 21 is a flowchart illustrating an example of processing executed in the exemplary embodiment. More specifically, FIG. 21 illustrates an example of processing when communication is performed between the mobile information processing apparatus 210 and the document management apparatus 250 in the system configuration shown in FIG. 2B.

The document management apparatus 250 manages the disclosure (access) range of each document, the state of each terminal, and position information concerning the home location (the location of an organization, for example).

As a result of the document management apparatus 250 managing the above-described items of information, it is possible to deal with certain situations, for example, where changes are made to the above-described items of information, and there are some rules unique to a certain organization, such as the rule that the security of a terminal is unchanged even if some patches are not applied to the terminal).

In step S2102, a user 2110 accesses (opens) a document by using the mobile information processing apparatus 210.

In step S2104, the mobile information processing apparatus 210 requests the document management apparatus 250 to obtain the disclosure range (security level) of the document by using the document ID, the security state of the terminal by using the terminal ID, and information indicating whether access is made within the home location by using GPS information or network information.

In step S2106, the document management apparatus 250 sends the disclosure range, security state, and information indicating whether access is made within the home location to the mobile information processing apparatus 210.

In step S2108, the mobile information processing apparatus 210 changes the display mode in accordance with disclosure range, security state, and information indicating whether access is made within the home location.

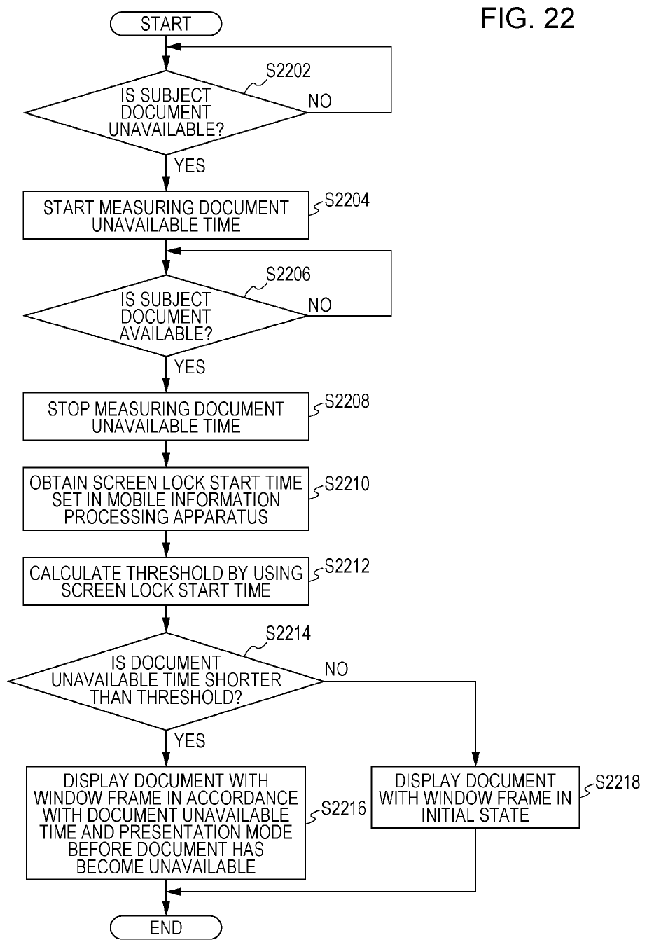

FIG. 22 is a flowchart illustrating an example of processing executed in the exemplary embodiment. More specifically, FIG. 22 illustrates an example of processing for changing the presentation mode of a document under the following condition. A document is set to be unavailable for access and is then set to be available again. The presentation mode of the document is changed in accordance with the time for which the document has been unavailable (hereinafter called the document unavailable time).

In step S2202, the information processing device 100 judges whether a subject document is unavailable for access. If the subject document is unavailable, the process proceeds to step S2204. If the document is available, the information processing device 100 waits until the document becomes unavailable.

In step S2204, the information processing device 100 starts measuring the document unavailable time.

In step S2206, the information processing device 100 judges whether the subject document has become available for access. If the document has become available, the process proceeds to step S2208. If the document has not become available, the information processing device 100 waits until the document becomes available.

In step S2208, the information processing device 100 stops measuring the document unavailable time.

In step S2210, the information processing device 100 obtains a screen lock start time set in the mobile information processing apparatus 200.

In step S2212, the information processing device 100 calculates a threshold by using the screen lock start time. For example, to calculate the threshold, the information processing device 100 may multiply the screen lock start time by a predetermined value (1 or greater) or add a predetermined value (0 or greater) to the screen lock start time.

The reason why the threshold is set to be longer than the screen lock start time is that the threshold is used as a standard (criteria) for judging whether a user has restarted the document merely after a brief interruption, that is, whether the display state will be returned to the previous state. The document unavailable time as short as the screen lock start time is regarded as merely a brief interruption.

In step S2214, the information processing device 100 judges whether the document unavailable time is shorter than the threshold. If the document unavailable time is shorter than the threshold, the process proceeds to step S2216. If the document unavailable time is not shorter than the threshold, the process proceeds to step S2218.

In step S2216, the information processing device 100 displays the document with a window frame in accordance with the document unavailable time and the presentation mode in which the document has been displayed before the document becomes unavailable.

In step S2218, the information processing device 100 displays the document with a window frame in the initial state.

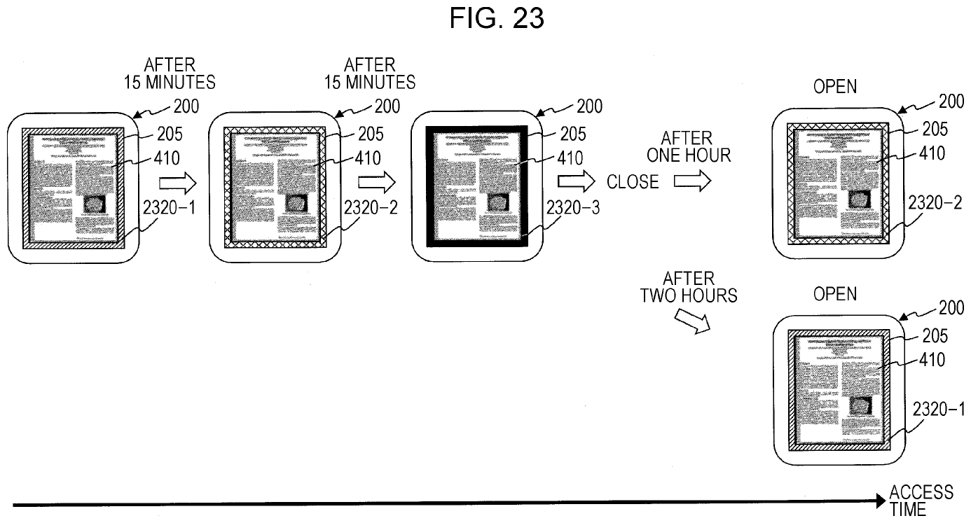

FIG. 23 illustrates an example of processing executed in the exemplary embodiment.

It is now assumed that the screen lock start time set in the mobile information processing apparatus 200 is one hour and the threshold used in step S2214 is one hour and five minutes.

When a document 410 is opened for the first time, a window frame 2320-1 in the initial state is in green, and is switched to a window frame 2320-2 in yellow after 15 minutes, and is further switched to a window frame 2320-3 in red after another 15 minutes. At this time point, the document 410 is closed.

After the lapse of one hour, the document 410 is reopened. In this case, the document 410 is displayed with the window frame 2320-2 in yellow, instead of the window frame 2320-1 in green, because the document 410 is reopened within a time indicated by the threshold. This can call a user's attention to the possibility of unauthorized access. In this example, the document 410 is reopened with the window frame 2320-2 in yellow rather than with the window frame 2320-3 in red, which is the presentation state immediately before the document 410 is closed. However, the document 410 may be reopened with the window frame 2320-3 in red. It may be possible to choose one of the window frame 2320-3 in red and the window frame 2320-2 in yellow in accordance with the document unavailable time. More specifically, if the document unavailable time is shorter than or equal to a predetermined threshold, which is smaller than the threshold used in step S2214, the document 410 is reopened with the window frame 2320-3 in red. If the document unavailable time exceeds the predetermined threshold, the document 410 is reopened with the window frame 2320-2 in yellow.

If the document 410 is reopened after the lapse of two hours after the document 410 is closed, it is displayed with the window frame 2320-1 in green in the initial state because the document 410 is reopened in a time exceeding the threshold used in step S2214.

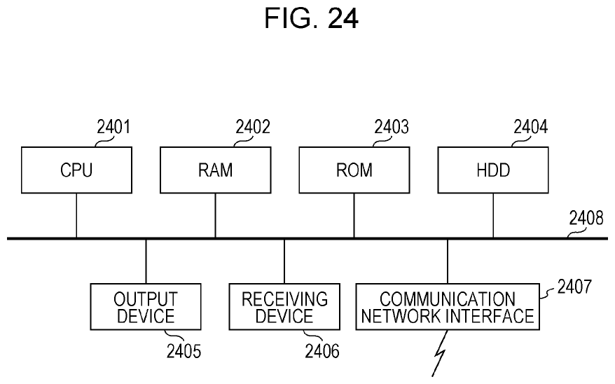

The hardware configuration of a computer in which a program serving as the exemplary embodiment is executed is the configuration of a general computer, such as a PC or a server, as shown in FIG. 24. More specifically, such a computer uses a CPU 2401 as a processor (operation unit) and a RAM 2402, a read only memory (ROM) 2403, and a hard disk drive (HDD) 2404 as storage devices. As the HDD 2404, a hard disk or a solid state drive (SSD), which is a flash memory, may be used. The computer includes the CPU 2401, the RAM 2402, the ROM 2403, the HDD 2404, which is an auxiliary storage device, an output device 2405, a receiving device 2406, a communication network interface 2407, and a bus 2408. The CPU 2401 executes a program, such as the control module 105 including the calculation module 110 and the display control module 115, and the display module 120. The RAM 2402 stores this program and data therein. The ROM 2403 stores a program for starting the computer. Examples of the output device 2405 are a cathode ray tube (CRT), a liquid crystal display, and a speaker. The receiving device 2406 receives data based on an operation (including motion, sound, and gaze) performed by a user on a keyboard, a mouse, a touchscreen, a microphone, or a camera (including a gaze detection camera). The communication network interface 2407 is, for example, a network interface card, for communicating with a communication network. The above-described elements are connected to one another via the bus 2408 and send and receive data to and from one another. The above-described computer may be connected to another computer configured similarly to this computer via a network.

In the above-described exemplary embodiment, concerning elements implemented by a software computer program, such a computer program is read into a system having the hardware configuration shown in FIG. 24, and the above-described exemplary embodiment is implemented by a combination of software and hardware resources.

The hardware configuration shown in FIG. 24 is only an example, and the exemplary embodiment may be configured in any manner in which the modules described in the exemplary embodiment are executable. For example, some modules may be configured as dedicated hardware (for example, an application specific integrated circuit (ASIC)), or some modules may be installed in an external system and be connected to the PC via a communication line. A system, such as that shown in FIG. 24, may be connected to a system, such as that shown in FIG. 24, via a communication line, and may be operated in cooperation with each other. Additionally, instead of into a PC, the modules may be integrated into a mobile information communication device (including a cellular phone, a smartphone, a mobile device, and a wearable computer), a home information appliance, a robot, a copying machine, a fax machine, a scanner, a printer, or a multifunction device (image processing apparatus including two or more functions among a scanner, a printer, a copying machine, and a fax machine).

In the above-described exemplary embodiment, when comparing a certain value with a predetermined value, “greater than or equal to”, “smaller than or equal to”, “greater than”, and “smaller than” may also be read as “greater than”, “smaller than”, “greater than or equal to”, and “smaller than or equal to”, respectively, unless there is an inconsistency between a combination of two values to be compared.

The above-described program may be stored in a recording medium and be provided. The program recorded on a recording medium may be provided via a communication medium. In this case, the above-described program may be implemented as a “non-transitory computer readable medium storing the program therein” in the exemplary embodiment.

The “non-transitory computer readable medium storing a program therein” is a recording medium storing a program therein that can be read by a computer, and is used for installing, executing, and distributing the program.

Examples of the recording medium are digital versatile disks (DVDs), and more specifically, DVDs standardized by the DVD Forum, such as DVD-R, DVD-RW, and DVD-RAM, DVDs standardized by the DVD+RW Alliance, such as DVD+R and DVD+RW, compact discs (CDs), and more specifically, a CD read only memory (CD-ROM), a CD recordable (CD-R), and a CD rewritable (CD-RW), Blu-ray (registered trademark) disc, a magneto-optical disk (MO), a flexible disk (FD), magnetic tape, a hard disk, a ROM, an electrically erasable programmable read only memory (EEPROM) (registered trademark), a flash memory, a RAM, a secure digital (SD) memory card, etc.

The entirety or part of the above-described program may be recorded on such a recording medium and stored therein or distributed. Alternatively, the entirety or part of the program may be transmitted through communication by using a transmission medium, such as a wired network used for a local area network (LAN), a metropolitan area network (MAN), a wide area network (WAN), the Internet, an intranet, or an extranet, a wireless communication network, or a combination of such networks. The program may be transmitted by using carrier waves.

The above-described program may be the entirety or part of another program, or may be recorded, together with another program, on a recording medium. The program may be divided and recorded on plural recording media. Further, the program may be recorded in any form, for example, it may be compressed or encrypted, as long as it can be reconstructed.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing device comprising:
a display that displays a document that an authorized user having an authorization is able to access; and
a changing unit that changes a presentation mode of the document in accordance with a probability that an unauthorized user is able to view or read content of the document, the probability being calculated from a situation where the authorized user is displaying the document.

2. The information processing device according to claim 1, wherein the changing unit changes the presentation mode of the document in accordance with a time for which the document is being displayed.

3. The information processing device according to claim 2, wherein the time for which the document is being displayed is a time for which no operation is performed on the displayed document.

4. The information processing device according to claim 1, wherein, if the document is set to be unavailable for access and is then displayed again in a state in which the document is available for access, the changing unit changes the presentation mode of the document to a presentation mode in which the document has been displayed before the document is set to be unavailable for access.

5. The information processing device according to claim 4, wherein, if a time from when the document is set to be unavailable for access until when the document is displayed again is greater than or equal to a threshold or exceeds the threshold, the changing unit changes the presentation mode of the document to a presentation mode in which the document has been displayed for the first time rather than to a presentation mode in which the document has been displayed immediately before the document is set to be unavailable for access.

6. The information processing device according to claim 4, wherein the changing unit changes the presentation mode of the document by comparing a time from when the document is set to be unavailable for access until when the document is displayed again with a threshold determined by using a screen lock start time.

7. The information processing device according to claim 6, wherein the changing unit sets the threshold to be a time longer than the screen lock start time, and changes the presentation mode of the document if the time for which the document has been unavailable is smaller than or smaller than or equal to the threshold.

8. A non-transitory computer readable medium storing a program causing a computer to execute a process, the process comprising:
displaying a document that an authorized user having an authorization is able to access; and
changing a presentation mode of the document in accordance with a probability that an unauthorized user is able to view or read content of the document, the probability being calculated from a situation where the authorized user is displaying the document.

9. An information processing device comprising:
display means for displaying a document that an authorized user having an authorization is able to access; and
changing means for changing a presentation mode of the document in accordance with a probability that an unauthorized user is able to view or read content of the document, the probability being calculated from a situation where the authorized user is displaying the document.
